(19) United States
(12) Patent Application Publication
(10) Pub. No.: US 2023/0016105 A1
(43) Pub. Date: Jan. 19, 2023

(54) HEAT TRANSFER DEVICE, TURBOMACHINE CASING AND RELATED STORAGE MEDIUM

(71) Applicant: General Electric Company, Schenectady, NY (US)

(72) Inventors: Robert Jamiolkowski, Zabki (PL); Karol Filip Leszczynski, HenryKow Urocze (PL); Wojciech Grzeszczak, Warszawa (PL); James William Vehr, Easley, SC (US); Robert Jacek Zreda, Warszawa (PL)

(21) Appl. No.: 17/933,981

(22) Filed: Sep. 21, 2022

Related U.S. Application Data
(63) Continuation of application No. 15/369,291, filed on Dec. 5, 2016.

(30) Foreign Application Priority Data
Jun. 7, 2016 (PL) 2016/050027

(51) Int. Cl. F23R 3/00; F01D 25/14; F01D 11/24

(52) U.S. Cl. CPC F23R 3/005; F01D 25/14; F01D 11/24; F05D 2230/31; F23R 2900/03044; F23R 2900/00018; F05D 2260/201

(57) ABSTRACT

Various embodiments include a heat transfer device, a turbomachine casing and a related storage medium. In some cases, the device includes: a body having an outer surface and an inner cavity within the outer surface; at least one aperture extending through the body, the at least one aperture positioned to direct fluid from the inner cavity through the body to the outer surface; a first lip proximate a first end of the body, and a second lip proximate a second end of the body, the first lip and the second lip each extending radially outward from the outer surface relative to a direction of flow of the fluid through the inner cavity; and a plug coupled with the body, the plug for obstructing an end of the inner cavity, the plug positioned to redirect flow of the fluid from a first direction to a second, distinct direction.

### FIELD OF THE INVENTION

The present subject matter is related to turbomachines. More particularly, the present subject matter is directed to heat transfer in turbomachines.

### BACKGROUND OF THE INVENTION

Turbomachine systems are continuously being modified to increase efficiency and decrease cost. One method for increasing the efficiency of a turbomachine system includes increasing the operating temperature of the turbomachine system. To increase the temperature, the turbomachine system is constructed of materials which can withstand such temperatures during use.

Within turbomachine systems, a casing component (casing) generally houses a nozzle/vane component (nozzle section). A working fluid is channeled through the turbomachine system, via the nozzle section, toward a set of buckets/blades, which rotate to drive one or more outputs e.g., a dynamoelectric machine. Because the working fluid directly contacts the nozzle section, the heat from that working fluid often increases the temperature of the components in that nozzle section, causing them to expand. If the casing and the nozzle section are not sufficiently separated from one another, expansion of the nozzle section due to heating can cause rubbing with the casing, decreasing the turbomachine efficiency as well as reducing the lifespan of components in the turbomachine system.

### BRIEF DESCRIPTION OF THE INVENTION

Various embodiments include a heat transfer device, a turbomachine casing, and a related storage medium. In some cases, the device includes: a body having an outer surface and an inner cavity within the outer surface; at least one aperture extending through the body, the at least one aperture positioned to direct fluid from the inner cavity through the body to the outer surface; a first lip proximate a first end of the body, and a second lip proximate a second end of the body, the first lip and the second lip each extending radially outward from the outer surface relative to a direction of flow of the fluid through the inner cavity; and a plug coupled with the body, the plug for obstructing an end of the inner cavity, the plug positioned to redirect flow of the fluid from a first direction to a second, distinct direction.

A first aspect of the disclosure includes a device having: a body having an outer surface and an inner cavity within the outer surface; at least one aperture extending through the body, the at least one aperture positioned to direct fluid from the inner cavity through the body to the outer surface; a first lip proximate a first end of the body, and a second lip proximate a second end of the body, the first lip and the second lip each extending radially outward from the outer surface relative to a direction of flow of the fluid through the inner cavity; and a plug coupled with the body, the plug for obstructing an end of the inner cavity, the plug positioned to redirect flow of the fluid from a first direction to a second, distinct direction.

A second aspect of the disclosure includes a turbomachine casing including: an axial flow path, the axial flow path including a first portion and a second portion axially downstream of the first portion; a nozzle cavity fluidly coupled with the axial flow path; a passageway fluidly connecting the axial flow path and the nozzle cavity; and an impingement sleeve within the second portion of the axial flow path, the impingement sleeve including: a body having an outer surface and an inner cavity within the outer surface, wherein the inner cavity is fluidly coupled with the first portion of the axial flow path; at least one aperture extending through the body, the at least one aperture positioned to direct fluid from the inner cavity through the body to the outer surface; and a first lip proximate a first end of the body, the first lip extending radially outward from the outer surface and sealing the first portion of the axial flow path from the second portion of the axial flow path.

A third aspect of the disclosure includes a non-transitory computer readable storage medium storing code representative of an device, the device physically generated upon execution of the code by a computerized additive manufacturing system, the code including: code representing the device, the device including: a body having an outer surface and an inner cavity within the outer surface; at least one aperture extending through the body, the at least one aperture positioned to direct fluid from the inner cavity through the body to the outer surface; a first lip proximate a first end of the body, and a second lip proximate a second end of the body, the first lip and the second lip each extending radially outward from the outer surface relative to a direction of flow of the fluid through the inner cavity; and a plug coupled with the body, the plug for obstructing an end of the inner cavity, the plug positioned to redirect flow of the fluid from a first direction to a second, distinct direction.

### BRIEF DESCRIPTION OF THE DRAWINGS

FIG. 1 shows a cross-sectional view of a device within an article, according to various embodiments of the disclosure.

FIG. 2 shows a perspective view of the device of FIG. 1, according to embodiments of the disclosure.

FIG. 3 is a schematic perspective view of a portion of a turbomachine including a device illustrating fluid flow according to various embodiments of the disclosure.

FIG. 4 is a schematic perspective view of a device within a turbomachine according to various embodiments of the disclosure.

FIG. 5 is a close-up depiction of a portion of the device of FIG. 4, according to various embodiments of the disclosure.

FIG. 6 shows a block diagram of an additive manufacturing process including a non-transitory computer readable storage medium storing code representative of a template according to embodiments of the disclosure.

Wherever possible, the same reference numbers will be used throughout the drawings to represent the same parts.

### DETAILED DESCRIPTION OF THE INVENTION

Provided are a device (e.g., impingement sleeve) and casing (e.g., turbomachine casing) including such a device, for transferring heat within the casing. Embodiments of the present disclosure, for example, in comparison to concepts failing to include one or more of the features disclosed herein, may improve operation in a turbomachine (e.g., gas turbine or steam turbine), e.g., by increasing cooling efficiency, reducing cross flow, reducing cross flow degradation, reducing pressure loss, increasing backflow margins, providing increased heat transfer with reduced pressure drop, facilitating reuse of heat transfer fluid, facilitating series impingement cooling, increasing article life, facilitating use of increased system temperatures, increasing system efficiency, or a combination thereof.

As used herein, the terms “axial” and/or “axially” refer to the relative position/direction of objects along axis A, which is substantially parallel with the axis of rotation of the turbomachine (in particular, the rotor section). As further used herein, the terms “radial” and/or “radially” refer to the relative position/direction of objects along axis (r), which is substantially perpendicular with axis A and intersects axis A at only one location. Additionally, the terms “circumferential” and/or “circumferentially” refer to the relative position/direction of objects along a circumference which surrounds axis A but does not intersect the axis A at any location.

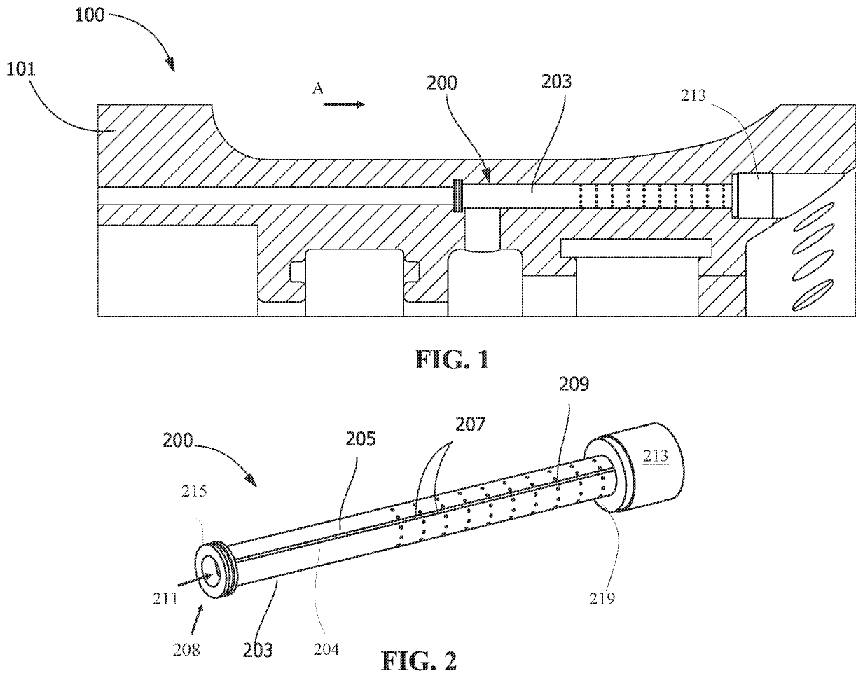

FIGS. 1-2 illustrate one embodiment of an article 100 (FIG. 1) and a device 200 (FIG. 2) positioned within article 100. Article 100 and/or device 200 are formed according to any suitable manufacturing method. Suitable manufacturing methods include, but are not limited to, casting, machining, additive manufacturing, or a combination thereof. For example, as described herein, additive manufacturing of device 200 may include direct metal laser melting (DMLM), direct metal laser sintering (DMLS), selective laser melting (SLM), selective laser sintering (SLS), fused deposition modeling (FDM), three-dimensional (3D) printing, any other additive manufacturing technique, or a combination thereof.

Referring to FIG. 1, in one embodiment, article 100 includes, but is not limited to, a turbomachine casing (shell) 101 or component thereof. For example, in one embodiment, as illustrated in FIGS. 1, 3 and 4, article 100 includes a turbomachine casing 101 and the device 200 includes a curved and/or cylindrical impingement sleeve (impingement sleeve) 203.

Impingement sleeve 203 can include an elongated tube-shaped body 204 (FIG. 2), and have a plurality of the apertures 207 formed therein, where apertures 207 are configured to direct a heat transfer fluid (e.g., a gas or liquid) towards turbomachine casing 101 surrounding (cylindrical) impingement sleeve 203. In various embodiments, apertures 207 are disposed circumferentially about body 204, and include apertures 207 which are axially adjacent one another (i.e., adjacent apertures 207 are disposed along the axis of fluid flow entering impingement sleeve 203). In various embodiments, apertures 207 can include substantially circular openings in body 204, however, in other embodiments, apertures 207 can include oblong, rectangular, polygonal, or other-shaped openings in body 204. In various embodiments, apertures 207 are approximately 0.05 inches (˜0.125 centimeters (cm)) to approximately 0.1 inches (˜0.25 cm) wide, and in some particular cases between approximately 0.065 inches (0.16 cm) and 0.075 inches (0.2 cm) wide, which can be measured at the widest opening in apertures 207. In some cases, the size, shape and arrangement of apertures 207 may vary across body 204.

Additionally, in some embodiments, impingement sleeve 203 can include one or more fluid receiving features 209 formed in the outer surface 205 thereof. Fluid receiving features 209 can include, e.g., one or more slots, holes, troughs or passageways allowing for movement of fluid therethrough. In some cases, fluid receiving features 209 include a fluid directing feature, which directs flow of fluid (e.g., heat transfer fluid) away from apertures 207. Apertures 207 are configured to direct the heat transfer fluid from an inner cavity 211 within cylindrical impingement sleeve 203, to curved outer surface 205 of impingement sleeve 203, and subsequently, to the curved surface of turbomachine casing 101 to form fountain regions (which may, in some cases, be directed back into the fluid receiving features 209 in the cylindrical impingement sleeve 203). Inner cavity 211 can extend substantially entirely through the body of impingement sleeve 203 (along axial direction A, coinciding with the primary axis of the turbomachine in which casing 101 belongs, and primary axis of flow into the inlet 208 of inner cavity 211), and may terminate (dead-end) at a junction of the impingement sleeve 203 and adjacent plug 213.

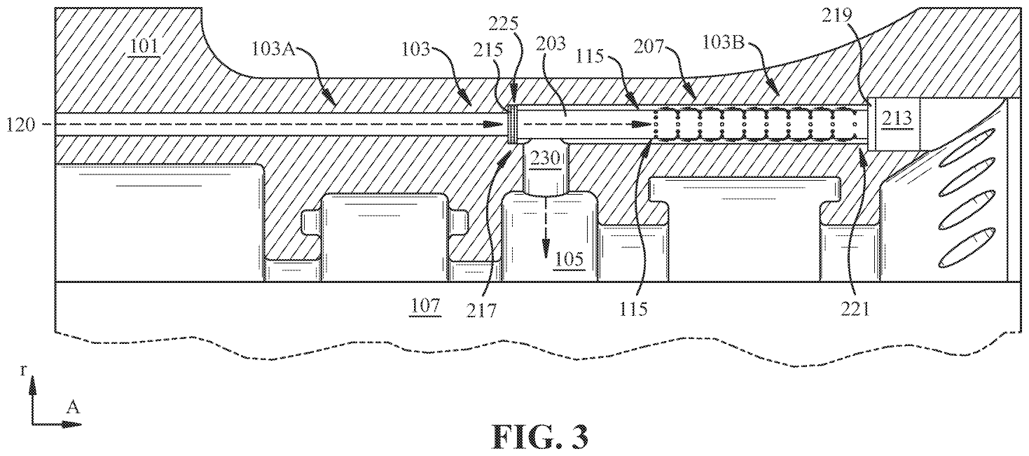

FIG. 3 shows a schematic perspective view of turbomachine casing 101 and impingement sleeve 203, further illustrating fluid flow within casing 101 relative to impingement sleeve 203. As shown, turbomachine casing 101 can include an axial flow path 103, located radially outboard of (radially farther from central axis of turbomachine) a nozzle cavity 105. Nozzle cavity 105, as is known in the art, can include a space proximate the turbomachine nozzles where heat transfer fluid is diverted to reduce a temperature difference between the inner nozzle section 107 of the turbomachine and the turbomachine casing 101. In various embodiments, axial flow path 103 include two portions: a first portion 103A and a second portion 103B axially downstream (farther from fluid inlet) of first portion and fluidly connected with first portion 103A. Second portion 103B is shown partially filled in this depiction with impingement sleeve 203. Second portion 103B can have a larger inner diameter than first portion 103A, which may accommodate impingement sleeve 203. As shown in FIGS. 1-3, impingement sleeve 203 can include a first lip 215 proximate a first end 217 and a second lip 219 proximate a second end 221 (opposite first end 217). In some cases, as shown in FIGS. 2 and 3, second lip 219 is coupled with plug 213 (e.g., within axial flow path 103), e.g., via force-fit, adhesive, coupling mechanism such as a screw, bolt, clamp, etc., welded and/or brazed connection, etc.

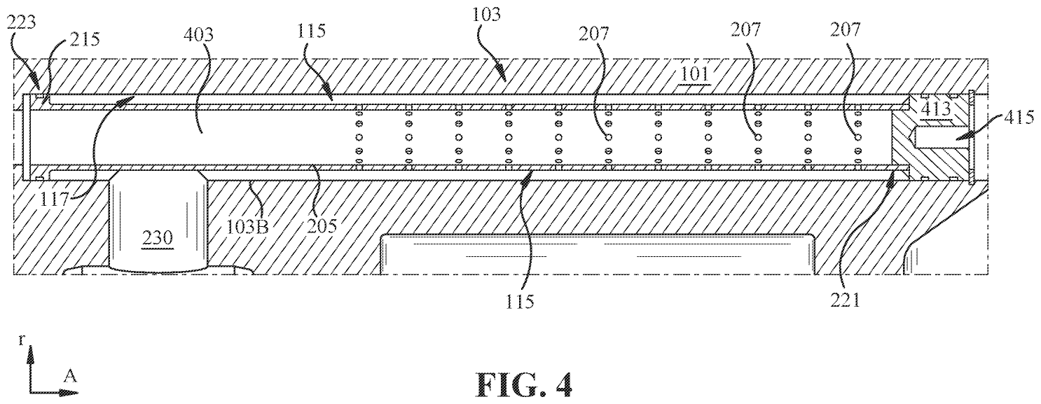

In various embodiments, first lip 215 and second lip 219 include protrusions extending radially outward (relative to primary axis of fluid flow through inner cavity) from outer surface 205 of impingement sleeve 203. Within turbomachine casing 101, first lip 215 and second lip 219 can define a circumferential space 115 between outer surface 205 of impingement sleeve 203 and an inner surface 117 of second portion 103B of cavity 103 (FIG. 4), such that the portions of impingement sleeve 203 extending between first lip 215 and second lip 219 do not contact the inner surface of second portion of 103B of cavity 203. In various embodiments, first lip 215 includes a circumferentially extending slot 223 which is sized to receive a seal (e.g., a seal ring) 225. First lip 215, including seal ring 225, can fluidly seal second portion 103B of axial cavity 103 from first portion 103A of axial cavity 103, such that the flow of heat transfer fluid 120 (e.g., gas such as air, or cooling liquid such as water) through first portion 103A is forced to flow axially into inner cavity of impingement sleeve 203. As shown, heat transfer fluid 120 can flow through first portion 103A of cavity 103, into impingement sleeve 203 (via internal cavity 211, FIG. 2), exit impingement sleeve 203 via on or more apertures 207 (where plug 213 terminates internal cavity 211, and forces flow to reverse), and flow through circumferential space 115 to a passageway (radially extending passageway) 230 fluidly coupling second portion 103B of axial cavity 103 with nozzle cavity 105. This heat transfer fluid 120 may then be used for downstream or upstream operation, including additional heat transfer uses and/or integration with a working fluid, e.g., hot gas.

It is understood that various embodiments of impingement sleeve 203 need not include fluid receiving feature(s) 209 depicted in FIG. 2, given the fluid dynamics illustrated in FIG. 3. However, some embodiments may include fluid receiving feature(s) 209, which may extend axially within outer surface 205 and help to guide flow of heat transfer fluid 120 from apertures 207 toward passageway 230.

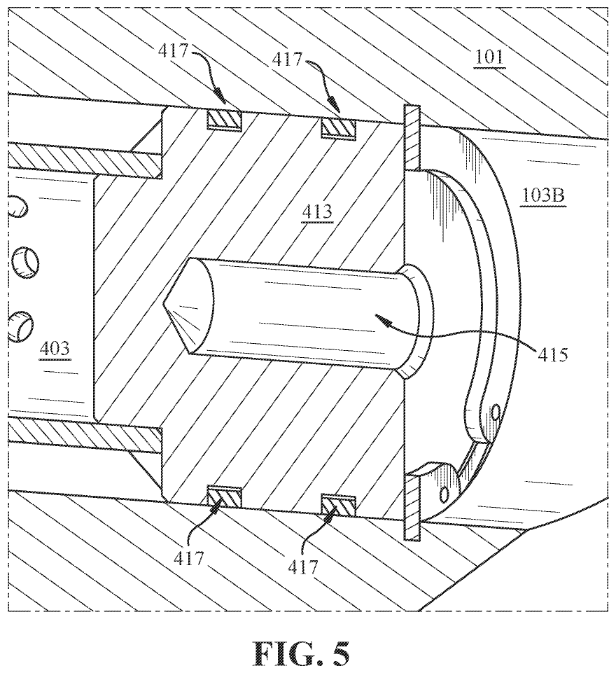

FIG. 4 shows a schematic depiction of another embodiment of an impingement sleeve 403, which includes a plug 413 (cross-sectional view shown) sealing second end 221 of sleeve 403, whereby plug 413 is matingly coupled with internal cavity 111 at second end 221 (e.g., portion of plug 413 fits within internal cavity 111). In these cases, plug 413 may include a portion that complements the opening within internal cavity 111 and matingly fits (e.g., force fit, compression fit, etc.) or couples with impingement sleeve 413. Impingement sleeve 413 may not include a second lip 219 (FIG. 3), and as such, plug 413 may matingly engage directly with internal cavity 111, as opposed to contacting or otherwise coupling with second lip 219 (FIG. 3). FIG. 5 shows a close-up view of plug 413 mated with second end 221. In some cases, plug 413 can include an internal aperture 415, e.g., for removal of plug 413 from impingement sleeve 403, and at least one circumferential slot 417, e.g., for receiving a seal member such as a seal ring or a retaining ring (e.g., for axially retaining impingement sleeve 403 and/or plug 413).

According to various embodiments, with reference to FIGS. 1-5, heat transfer fluid 120 (e.g., depicted in FIG. 3) includes hot gas from another section of a turbomachine or another machine, which is routed to axial flow path 103 to help reduce the temperature differential between casing 101 and nozzle section 107. That is, while components within nozzle section 107 are subjected to high-temperature working fluid such as gas or steam, those components can heat up and expand. If the surrounding casing 101 does not heat as quickly, or to the same degree as nozzle section 107, one or more components within nozzle section 107 can interfere (e.g., rub, contact, etc.) with casing 101 and degrade performance of the machine.

As shown and described herein, impingement sleeves 103, 403 can be implemented in casing 101 to enhance heat transfer in the casing 101 and decrease the differential temperature between casing 101 and nozzle section. In various embodiments, as illustrated in FIG. 3, heat transfer fluid 120 enters impingement sleeve 103 (or 403, FIG. 4) and flows axially in a first direction (e.g., substantially parallel with axis A). Due to its fluid velocity and direction, heat transfer fluid 120 may flow through impingement sleeve 103 and contact plug 213 (or plug 413, FIG. 3) which obstructs internal cavity 211 at its distal end (second end 221 of impingement sleeve 103). Plug 213 (413) may redirect (deflect) flow of heat transfer fluid 120 from the first direction to a second, distinct direction. In various embodiments, the second, distinct direction is distinct from the first direction of fluid flow by between approximately ninety degrees and approximately one-hundred-eighty degrees. That is, in some cases, flow of heat transfer fluid 120 is substantially reversed when contacting plug 213, 413 (e.g., having a substantially flat contact surface, or a substantially angled, concave or convex surface), which causes heat transfer fluid 120 to deflect back toward first end 217 of impingement sleeve 203, and also radially outward toward apertures 207. Heat transfer fluid 120 may further travel through apertures 207, around at least a portion of outer surface 205 of impingement sleeve 203, and into passageway 230. This at least partial reversal of flow, and subsequent flow through apertures 207 and into passageway 230, enhances the amount of heat transferred to/from casing 101 via heat transfer fluid 120, thereby aiding in reduction of differential thermal effects from nozzle section 107.

Impingement sleeve 203, 403 (FIGS. 1-5) including components thereof (e.g., plug 213, 413) may be formed in a number of ways. In one embodiment, impingement sleeve 203, 403 may be formed by casting, machining, welding, extrusion, etc. In one embodiment, however, additive manufacturing is particularly suited for manufacturing impingement sleeve 203, 403 (FIGS. 1-6). As used herein, additive manufacturing (AM) may include any process of producing an object through the successive layering of material rather than the removal of material, which is the case with conventional processes. Additive manufacturing can create complex geometries without the use of any sort of tools, molds or fixtures, and with little or no waste material. Instead of machining components from solid billets of metal, much of which is cut away and discarded, the only material used in additive manufacturing is what is required to shape the part. Additive manufacturing processes may include but are not limited to: 3D printing, rapid prototyping (RP), direct digital manufacturing (DDM), selective laser melting (SLM) and direct metal laser melting (DMLM). In the current setting, DMLM has been found advantageous.

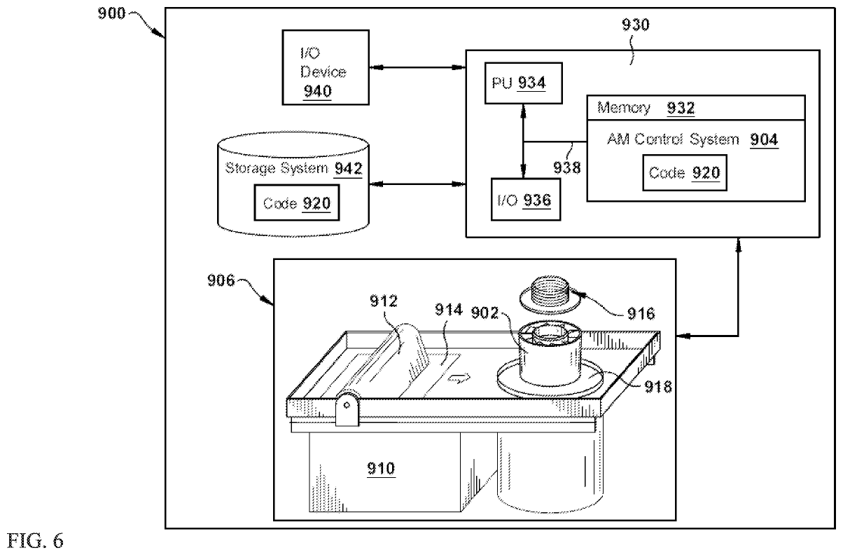

To illustrate an example of an additive manufacturing process, FIG. 6 shows a schematic/block view of an illustrative computerized additive manufacturing system 900 for generating an object 902. In this example, system 900 is arranged for DMLM. It is understood that the general teachings of the disclosure are equally applicable to other forms of additive manufacturing. Object 902 is illustrated as a double walled turbomachine element; however, it is understood that the additive manufacturing process can be readily adapted to manufacture impingement sleeve 203, 403 (FIGS. 1-5). AM system 900 generally includes a computerized additive manufacturing (AM) control system 904 and an AM printer 906. AM system 900, as will be described, executes code 920 that includes a set of computer-executable instructions defining impingement sleeve 203, 403 (FIGS. 1-5) to physically generate the object using AM printer 906. Each AM process may use different raw materials in the form of, for example, fine-grain powder, liquid (e.g., liquid metal), sheet, etc., a stock of which may be held in a chamber 910 of AM printer 906. In the instant case, impingement sleeve 203, 403 (FIGS. 1-5) may be made of metal or similar materials. As illustrated, an applicator 912 may create a thin layer of raw material 914 spread out as the blank canvas from which each successive slice of the final object will be created. In other cases, applicator 912 may directly apply or print the next layer onto a previous layer as defined by code 920, e.g., where the material is a metal. In the example shown, a laser or electron beam 916 fuses particles for each slice, as defined by code 920, but this may not be necessary where a quick setting liquid metal is employed. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of impingement sleeve 203, 403 (FIGS. 1-5), described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 940 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of impingement sleeve 203, 403 (FIGS. 1-5). As noted, code 920 includes a set of computer-executable instructions defining outer electrode that can be used to physically generate the tip, upon execution of the code by system 900. For example, code 920 may include a precisely defined 3D model of outer electrode and can be generated from any of a large variety of well-known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing impingement sleeve 203, 403 (FIGS. 1-5) into a series of thin slices that it assembles using AM printer 906 in successive layers of liquid, powder, sheet or other material. In the DMLM example, each layer is melted to the exact geometry defined by code 920 and fused to the preceding layer. Subsequently, the impingement sleeve 203, 403 (FIGS. 1-5) may be exposed to any variety of finishing processes, e.g., minor machining, sealing, polishing, assembly to other part of the igniter tip, etc.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

1-20. (canceled)

21. A turbomachine, the turbomachine comprising:
a turbomachine casing;
an axial flow path defined in the turbomachine casing, the axial flow path including a first portion and a second portion extending axially downstream from the first portion, the first portion of the axial flow path having a first cylindrical shape with a first diameter and the second portion of the axial flow path having a second cylindrical shape with a second diameter, the second diameter being larger than the first diameter;
a nozzle cavity defined radially inward of the axial flow path in the turbomachine casing and fluidly coupled with the axial flow path;
a radially extending passageway fluidly connecting the second portion of the axial flow path and the nozzle cavity, whereby fluid flow from the axial flow path flows through the radially extending passageway to the nozzle cavity; and
an impingement sleeve disposed within the second portion of the axial flow path, the impingement sleeve including:
a cylindrical body having an outer surface and an inner cavity defined within the outer surface, wherein the inner cavity is fluidly coupled with the first portion of the axial flow path, the outer surface is radially spaced from an inner surface of the second portion of the axial flow path, and the cylindrical body includes a first lip and a second lip, each of the first lip and the second lip extending radially outward from the outer surface; and
at least one aperture extending through the cylindrical body, the at least one aperture positioned to direct fluid from the inner cavity through the cylindrical body to impinge on the inner surface of the second portion of the axial flow path;
wherein the first lip is proximate to a first end of the cylindrical body and seals the first portion of the axial flow path from the second portion of the axial flow path, and wherein the second lip is proximate to a second end of the cylindrical body.

22. The turbomachine of claim 21, wherein the inner cavity includes an inlet proximate to the first end of the cylindrical body.

23. The turbomachine of claim 21, wherein the cylindrical body and the first lip define a circumferential space between the outer surface of the cylindrical body and the inner surface of the second portion of the axial flow path; and wherein the at least one aperture directs flow of the fluid from the inner cavity to the circumferential space.

24. The turbomachine of claim 23, wherein the first lip is shaped to direct flow of the fluid in the circumferential space to the radially extending passageway fluidly coupled with the nozzle cavity.

25. The turbomachine of claim 21, wherein the at least one aperture includes a plurality of apertures disposed in the cylindrical body.

26. The turbomachine of claim 25, wherein the plurality of apertures is disposed circumferentially about the cylindrical body and includes adjacent apertures disposed along the first direction of fluid flow.

27. The turbomachine of claim 21, further including at least one fluid receiving feature formed in the outer surface of the cylindrical body, the at least one fluid receiving feature positioned to receive fluid from the at least one aperture.

28. The turbomachine of claim 27, wherein the at least one fluid receiving feature further comprises a fluid directing feature, the fluid directing feature directing post-impingement fluid away from the at least one aperture.

29. The turbomachine of claim 21, wherein the first lip of the cylindrical body includes a slot, and wherein the impingement sleeve further includes a seal member within the slot for fluidly sealing the circumferential space from the first portion of the axial flow path.

30. The turbomachine of claim 21, further including:
a plug distinct and separate from the cylindrical body, the plug contacting a surface of the inner cavity of the cylindrical body and force fittingly engaged to and obstructing an end of the inner cavity at the second end of the cylindrical body, the plug positioned to redirect flow of the fluid from a first direction of fluid flow to a second, distinct direction of fluid flow;
wherein the second, distinct direction of fluid flow is off-set from the first direction of fluid flow by between about ninety degrees and about one-hundred-eighty degrees.

31. The turbomachine of claim 30, wherein the plug includes a contact surface within the inner cavity, such that fluid flowing in the first direction through the inner cavity strikes the contact surface and is deflected back in the second, distinct direction of fluid flow toward the first end of the impingement sleeve

32. The turbomachine of claim 30, wherein the plug includes a contact surface within the inner cavity, such that the fluid flowing in the first direction through the inner cavity strikes the contact surface and is directed radially outward in the second, distinct direction of flow toward and through the at least one aperture.

33. The turbomachine of claim 30, wherein the plug includes at least one circumferential slot defined therein, and a retaining ring in the at least one circumferential slot configured for axially retaining at least one of the impingement sleeve and the plug in the axial flow path.

34. The turbomachine of claim 30, wherein the plug includes an internal aperture defined therein and configured for removal of the plug from the impingement sleeve.

35. The turbomachine of claim 21, wherein the inner cavity includes an inlet proximate to the first end of the cylindrical body; wherein the at least one aperture includes a plurality of apertures; and wherein the plurality of apertures is disposed circumferentially about the cylindrical body and include adjacent apertures disposed along the axial flow path.
